(19) United States
(12) Patent Application Publication
(10) Pub. No.: US 2010/0022141 A1
(43) Pub. Date: Jan. 28, 2010

(54) ELECTRICAL CONNECTOR

(76) Inventor: Wen-Liang Wen, Chung Ho City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/178,843

(22) Filed: Jul. 24, 2008

(51) Int. Cl. H01R 24/00

(52) U.S. Cl. 439/676

(57) ABSTRACT

An electrical connector includes a rubber core body having a plurality of terminal holes and a plurality of open holes, the terminal holes penetrating front and rear sides of the rubber core body, the open holes being provided on upper and lower sides of the rubber core body and are in communication with the terminal holes respectively; and a plurality of conductive terminals inserted into the terminal holes of the rubber core body. Via this arrangement, the area between the conductive terminals is filled with air instead of solid media, which reduces permittivity. Therefore, the capacitance of conductive terminals is reduced and the impendence is increased.

### BACKGROUND OF THE INVENTION

1. Field of the Invention

The present invention relates to an electrical connector, and in particular to an electrical connector with a rubber core body that has open holes.

2. Description of Related Art

With the proliferation of various electronic products, there are more and more demands for a connector (such as an electrical connector) between respective electronic products. Therefore, it is an important issue for the industry in this art to generate better electrical properties for electrical connectors so that signals will not attenuate easily during high frequency transmission.

U.S. Pat. No. 6,997,733 discloses a conventional plug connector, which includes a rubber core body and a plurality of conductive terminals. The conductive terminals are inserted into terminal holes of the rubber core body. The rear end of each conductive terminal is connected to the core of a cable. The plug connector is inserted into a socket connector and electrically connected thereto. Via this arrangement, electrical signals in the cable can be transmitted to the socket connector of other electronic products via the plug connector.

However, the conventional plug connector has some drawbacks. In comparison with the impendence of the cable and that of the conductive terminals, the impendence of the cable is much larger, so that there is a mismatch of impendence between the cable and the conductive terminals. As a result, in transmitting signals to the conductive terminals, the signals in the cable may attenuate significantly, causing the distortion of signals. Especially, when the electrical connector is applied to high frequency transmission, the mismatch of impendence will attenuate the signals to a further extent. As a result, the attenuation of signals affects the quality of high frequency transmission more significantly.

Consequently, because of the above limitation resulting from the technical design of prior art, the inventor strives via real world experience and academic research to develop the present invention, which can effectively improve the limitations described above.

### SUMMARY OF THE INVENTION

The object of the present invention is to provide an electrical connector, in which a rubber core body has open holes to produce area between the conductive terminals with air, and because permittivity of air is much lower than permittivity in other media, thus the permittivity is decreased and lead to a decrease in capacitance. In this way, the impendence of conductive terminals can be increased due to the decrease in capacitance, thereby matching the impendence of the conductive terminals and that of the cable.

In order to achieve the above objects, the present invention provides an electrical connector, which includes a rubber core body having a plurality of terminal holes and a plurality of open holes, the terminal holes penetrating front and rear sides of the rubber core body, the open holes being provided on upper and lower sides of the rubber core body and in communication with the conductive holes respectively; and a plurality of conductive terminals inserted into the terminal holes of the rubber core body.

The present invention has advantageous features as follows. The rubber core body has the open holes, so that the area between the conductive terminals is filled with air when the conductive terminals are inserted into the rubber core body. In this way, the permittivity is decrease, and the capacitance of the conductive terminals can be reduced, which leads to the impendence of conductive terminals being increased.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a perspective view showing the electrical connector of the present invention;

FIG. 2 is an exploded perspective view showing the electrical connector of the present invention;

FIG. 3 is a schematic view showing the open holes of the rubber core body in the electrical connector of the present invention;

FIG. 4 is another schematic view showing the open holes of the rubber core body in the electrical connector of the present invention; and

FIG. 5 is a schematic view showing the open holes of the rubber core body in the electrical connector according to a second embodiment of the present invention.

### DETAILED DESCRIPTION OF THE PREFERRED EMBODIMENTS

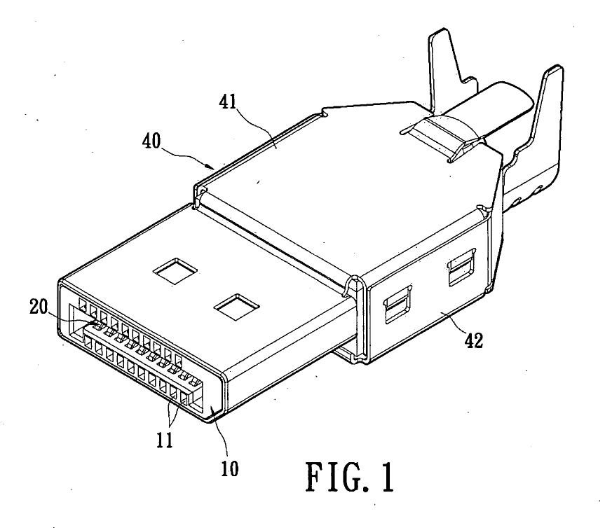

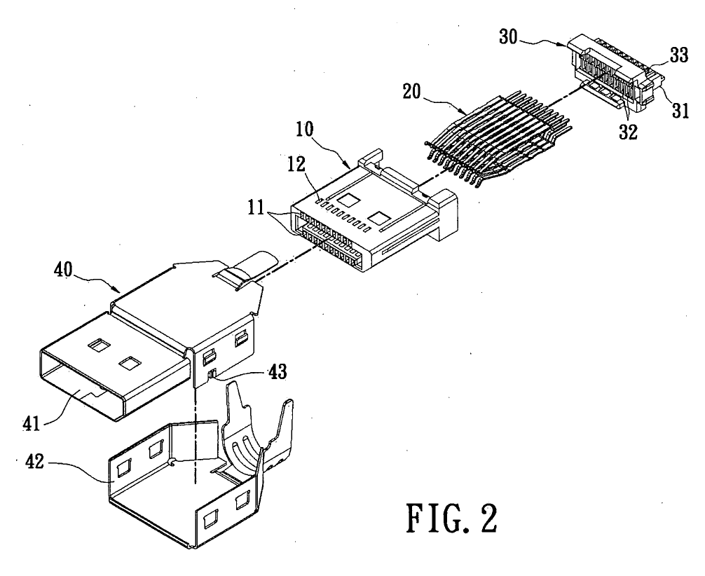

Please refer to FIGS. 1 to 2. The present invention provides an electrical connector, which includes a rubber core body 10, a plurality of conductive terminals 20, a rear plug 30 and an iron casing 40. The electrical connector is mainly for connecting to a display port connector.

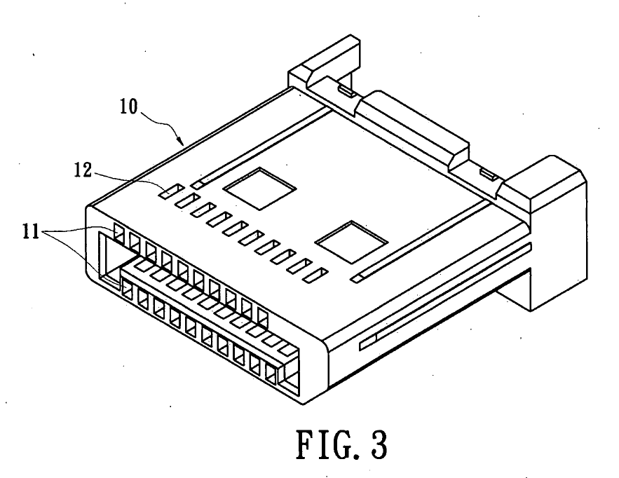

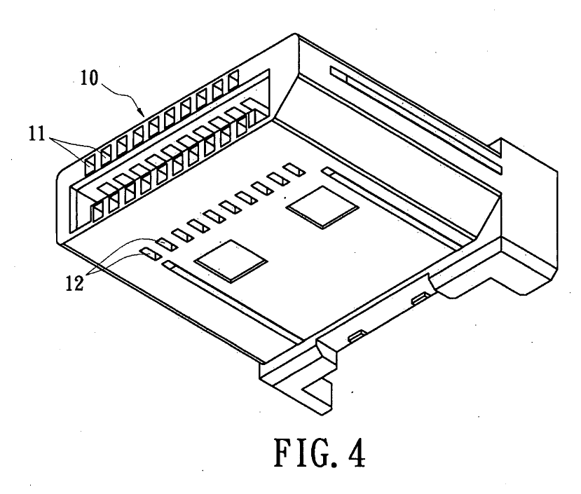

Please refer to FIGS. 3 and 4. The rubber core body 10 is made of an insulating material. The rubber core body 10 has a plurality of terminal holes 11 and a plurality of open holes 12. The terminal holes 11 are arranged horizontally and penetrate the front and rear sides of the rubber core body 10. The open holes 12 are provided on upper and lower sides of the rubber core body 10. The open holes 12 and are in communication with the terminal holes 11. In other embodiments, the open holes 12 may be only provided on the upper or the lower sides of the rubber core body 10 (not shown).

The conductive terminals 20 (FIG. 2) are made of metallic materials having a high coefficient of electric conductivity and are inserted orderly in the terminal holes 11 of the rubber core body 10. The rear ends of the conductive terminals 20 extend out of the rear side of the rubber core body 10.

Please view FIGS. 3 and 4 in conjunction with FIG. 2. The rear plug 30 is also made of an insulating material and is lodged in the rear end of the rubber core body 10. The rear plug 30 has a projection 31, a plurality of through holes 21 and a plurality of terminal troughs 33. The projection 31 extends rearwards from the rear side of the rear plug 30. The through holes 32 are arranged horizontally and penetrate the front and rear sides of the rear plug 30. The horizontally-arranged positions of the through holes 32 correspond to the positions of the terminal holes 11 of the rubber core body 10. The terminals 33 are provided on the projection 31 and are in communication with the through holes 32.

After the rear plug 30 is lodged in the rear end of the rubber core body 10, the rear ends of the conductive terminals 20 will pass through the through holes 32 of the rear plug 30 and extend into the terminal troughs 33 of the projection 31.

After the rubber core body 10, the conductive terminals 20 and the rear plug 30 are assembled completely, since the rubber core body 10 has the open holes 12 and the conductive terminals 20 correspond to the open holes 12 respectively, the amount of area between the conductive terminals 20 that is filled with air as suppose to solid media is increased (whereas, without the open holes, the space where :air occupies would occupied by solid media). The permittivity of air is much smaller than that of the rubber core body 10. For example, if the rubber core body 10 is made by plastics, its permittivity is in the range of 2.4 to 4 while the dielectric constant of air is 1.0054. For the same material, its permittivity is in proportion to the capacitance. Thus, the capacitance of conductive terminal 20 will be reduced due to the increase of the area between the conductive terminals being filled with air instead of solid media (i.e. for parallel plates, C=permittivity*(Area/distance)). On the other hand, for a material, its impendence is in inverse proportion to the capacitance. Thus, the lower the capacitance is, the larger the impendence is. Therefore, the impendence of the conductive terminals 20 will be increased due to the decrease of capacitance.

When the rear ends of the conductive terminals 20 are connected to cables (not shown) of larger impendence, the difference between the impendence of the conductive terminals 20 and the cable is not significant, so that the mismatch of impendence will not occur. Therefore, when the electrical connector of the present invention is applied to high frequency transmission, the transmitted high frequency signals will not be attenuated easily, and the distortion of signals will not occur easily.

Furthermore, according to the demands of manufactures, the size of open holes 12 of the rubber core body 10 can be adjusted easily. When the size of open holes 12 becomes larger, the impendence of conductive terminals 20 is increased accordingly, thereby matching different impendence of cables easily.

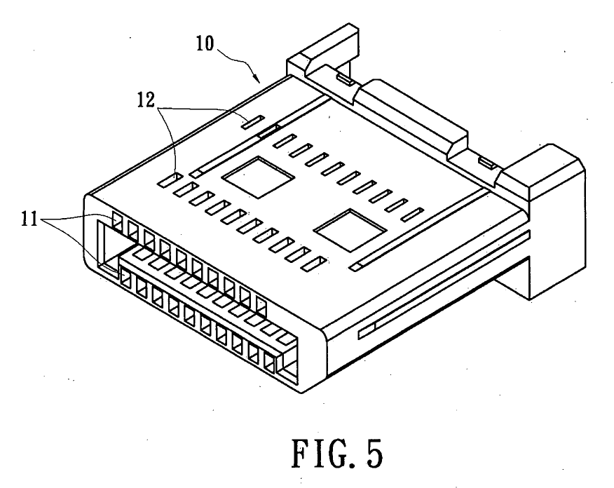

Please refer to FIG. 5, which shows a second embodiment of the present invention. The difference between the second embodiment and the first embodiment lies in that the upper and lower sides of the rubber core body 10 are provided with two rows of open holes 12. As a result, the area between the conductive terminals 20 that is filled with air can be further increased by additional one row of open holes 12, which decreases capacitance, and thereby increasing the impendence.

Please refer to FIGS. 1 and 2 again. After the rubber core body 10, the conductive terminals 20, the rear plug 30 and the cable (not shown) are assembled completely, the iron casing 40 is covered on the rubber core body 10, the rear plug 30 and the front end of the cable. The iron casing 40 has an upper casing 41 and a lower casing 42. In assembly, the upper casing 41 is put on the rubber core body 10 from the front end of the rubber core body 10. Then, the lower casing 42 is buckled to both sides (i.e. right and left side) of the upper casing 41 from the bottom of the upper casing 41. In this way, the rubber core body 10, the rear plug, and the front end of the cable can be covered and sandwiched between the upper casing 41 and the lower casing 42.

Furthermore, both sides of the iron casing 40 each have an inwardly-extending stopper 43 that is provided on the upper casing 41 or the lower casing 42. In the present invention, the stoppers 43 are provided on the upper casing 41. The stoppers 43 abut against the rear side of the rubber core body 10 in order to prevent the rubber core body 10 from sliding in the iron casing 40. As a result, the rubber core body 10 can be fixedly disposed in the iron casing 40.

The present invention has advantageous effects as follow. The rubber core body 10 has the open holes 12. Thus, when the conductive terminals 20 are inserted in the rubber core body 10, the area between the conductive terminals 20 being filled with air can be increased, thereby leads to the reducing of permittivity, and a reduction in capacitance of the conductive terminals 20. In this way, the impendence of conductive terminals 20 can be increased, thereby matching the impendence of cable.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electrical connector, comprising:
a rubber core body having a plurality of terminal holes and a plurality of open holes, the terminal holes penetrating the front and rear sides of the rubber core body, the open holes being provided on the upper and lower sides of the rubber core body and in communication with the terminal holes respectively; and
a plurality of conductive terminals inserted into the terminal holes of the rubber core body.

2. The electrical connector according to claim 1, wherein the rear end of the rubber core body is lodged by a rear plug, the rear plug has a plurality of terminal troughs, the rear ends of the conductive terminals are received in the terminal troughs respectively.

3. The electrical connector according to claim 1, wherein the electrical connector further comprises an iron casing that is covered outside the rubber core body.

4. The electrical connector according to claim 3, wherein the iron casing has an upper casing and a lower casing, and the upper casing is buckled to the lower casing.

5. The electrical connector according to claim 3, wherein both sides of the iron casing each have an inwardly-extending stopper, and the stoppers abut against the rear side surface of the rubber core body.

6. The electrical connector according to claim 1, wherein the electrical connector is a display port connector.

7. An electrical connector, comprising:
a rubber core body having a plurality of terminal holes and a plurality of open holes, the terminal holes penetrating the front and rear sides of the rubber core body, the open holes being provided on one side of the rubber core body and in communication with the terminal holes respectively; and
a plurality of conductive terminals inserted into the terminal holes of the rubber core body.

8. The electrical connector according to claim 7, wherein the electrical connector is a display port connector.
